(19) United States
(12) Patent Application Publication
(10) Pub. No.: US 2006/0038097 A1
(43) Pub. Date: Feb. 23, 2006

(54) Siderail mounting assembly

(75) Inventor: Mark G. Diller, Clayton, OH (US)

Correspondence Address: WOOD, HERRON & EVANS, LLP, 2700 CAREW TOWER, 441 VINE STREET, CINCINNATI, OH, 45202, US

(73) Assignee: Midmark Corporation, Versailles, OH (US)

(21) Appl. No.: 10/922,592

(22) Filed: Aug. 20, 2004

(51) Int. Cl. A47B 96/06; A47K 1/00; F21V 35/00

(52) U.S. Cl. 248/218.4; 248/221.12; 248/225.11

(57) ABSTRACT

An examination table having a side rail and mounting assembly for attaching a hand control to the table. The hand control has a key-hole shaped slot in its bottom wall which receives a stud projecting from a resilient clamp engaging the table rail. The stud is loosely received in the slot, which allows the hand control to remain substantially vertically oriented as the table and rail are moved through different positions.

### BACKGROUND OF THE INVENTION

Power examination tables and chairs are typically designed with a series of interconnected sections translatable with respect to each other so that the patient supporting surfaces may be oriented to various procedure positions, such as a Trendelenburg position or perhaps a favorite position preferred by a particular physician utilizing the table or chair. Both hand controls and foot controls are provided for controlling table or chair operation and while the foot controls are obviously placed on the floor, the hand control is usually attached to the table or chair.

Thus, in the case of the hand control, it will generally move with the chair as the chair is shifted between various positions, so that the hand control may be oriented in one position at one time and in a totally different position when the chair has been moved to a different procedural position. Also, if a table or chair is being retrofitted with a hand control there may in fact be no attachment on the table or chair to receive the hand control.

### SUMMARY OF THE INVENTION

The present invention provides a convenient mounting assembly for attaching a hand control to a power operated medical examination table or chair, which is easy to install and conveniently maintains the hand control in a substantially vertical orientation regardless of the position of the chair components.

Basically, the mounting assembly of the present invention comprises two components: a clamp and a housing. The clamp has opposed jaws and a bight portion and the housing, which houses the hand control, has a bottom wall. A keyhole slot and a stud receivable in the slot are mounted on the clamp and housing bottom wall so that the housing may be suspended from the clamp. The keyhole slot and stud components allow the housing to pivot freely with respect to the clamp, such that regardless of the position of the table components and the clamp which is attached to the table the housing always remains in a substantially vertical orientation.

More specifically, the clamp has a pair of opposed jaws which are designed to engage a rail of an examination table or chair. The clamp is preferably formed of a plastic or other resilient material so that the jaws and bight portion of the clamp are pressed into tight engagement with the surfaces of the power table or chair rail to which the clamp is applied. In a preferred embodiment of the invention the jaws have terminal ends which project inwardly toward each other and reversely curved portions joining the bight portion to dispose the bight portion inwardly between the terminal ends and the reversely curved portions. Thus, when the clamp is applied to a rail, opposite side surfaces of the rail are engaged by inner surfaces of the terminal ends of the jaws and the bight portion. This provides a secure anchorment which is not susceptible to being accidentally disengaged from the table or chair rail or moved out of position.

In a preferred embodiment of the invention the stud includes a shank which is attached at its inner end to the bight portion of the clamp and a disc mounted on an outer end of the shank. The housing bottom wall is preferably molded in one piece and the keyhole slot is formed in the bottom wall of a dimension complementary to the shank and disc of the stud.

It will be seen, therefore, that the clamp portion of the mounting assembly may be slipped onto the rail of an existing power examination table or chair to a desired position and the housing attached to the clamp via the keyhole slot and stud interengaging components, with the connection between the components being loose enough that the housing tends to hang in a vertically oriented position.

To facilitate sliding the clamp onto a rail the upper and lower surfaces of the clamp may be provided with a plurality of parallel ribs projecting outwardly from and extending longitudinally of the upper and lower surfaces of the clamp to facilitate gripping the clamp when attaching it to a table or chair rail. Preferably, the ribs taper in height from a maximum height medially of the length of the upper and lower surfaces of the jaws.

Additional objects, features and advantages of the invention will become apparent to those skilled in the art upon consideration of the following detailed description of the preferred embodiment exemplifying the best mode of carrying out the invention as presently perceived.

### BRIEF DESCRIPTION OF THE DRAWINGS

FIG. 1 is a perspective view of a mounting assembly clamp in accordance with the present invention;

FIG. 1A is a side elevational view of the clamp of FIG. 1 viewed from the opposite side;

FIG. 2 is a representation of a power actuated medical examination table depicting a side rail thereof and a mounting assembly in accordance with the present invention detached from said side rail;

FIG. 3 is an enlarged view of the mounting assembly of the present invention with the clamp thereof attached to a side rail of a power medical examination table or chair;

FIG. 4 is a side elevational view of the power medical examination table of FIG. 2 with the mounting assembly of the present invention attached to a side rail of the table and with the table components translated from the essentially flat configuration shown in FIG. 2 of the drawings;

FIG. 5 is a view similar to FIG. 4, but depicting the table in yet another procedural position and illustrating the fact that the hand control attached to the table by the mounting assembly of the present invention remains substantially vertically oriented throughout movement of the table components;

FIG. 6A is a view of a clamp attached to a side rail and a bottom wall of a hand control housing in position to be attached to the clamp, with the side rail and the hand control bottom wall being shown in section; and

FIG. 6B is a view taken on line 6-6 of FIG. 4 and showing the clamp and housing bottom wall engaged.

### DETAILED DESCRIPTION OF THE PREFERRED EMBODIMENTS

Turning initially to FIG. 2 of the drawings, an adjustable patient supporting device in the form of a power medical examination table is illustrated. The sections 12, 14 and 16 comprising the patient supporting surfaces are articulatable with respect to each other and powered through an operating unit 18 beneath the table, which is controlled in turn by a foot control 20 or a hand control 22. As seen in FIG. 2, the table 10 may have a side rail 24 onto which may be attached a clamp 26 in accordance with the present invention.

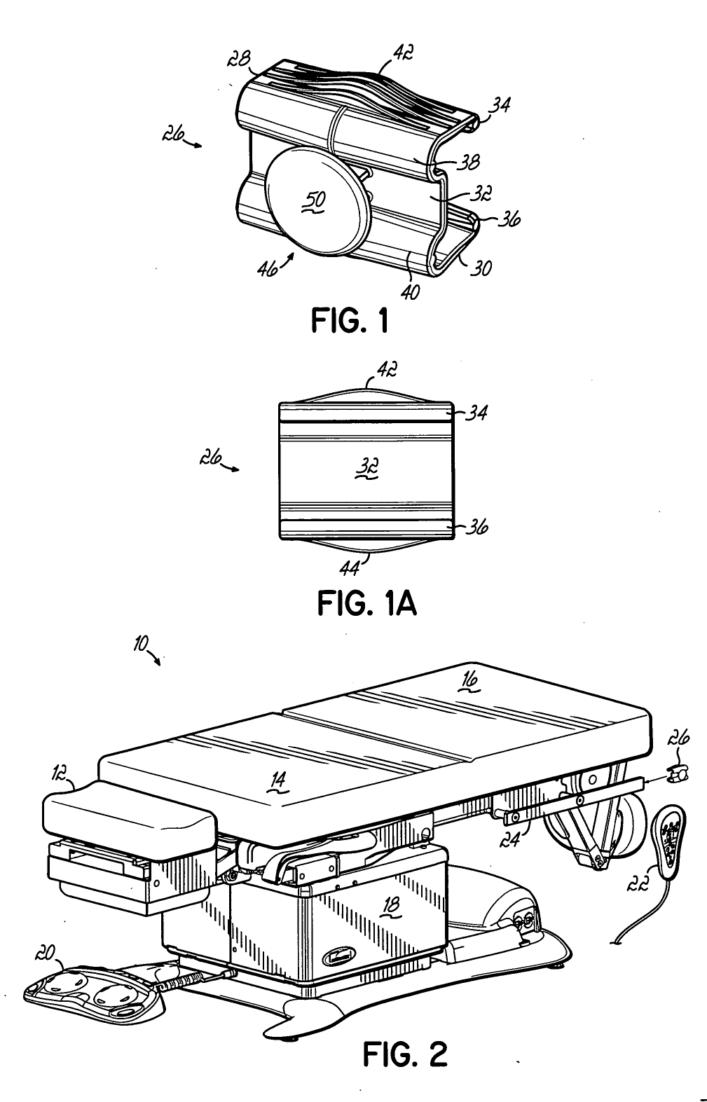

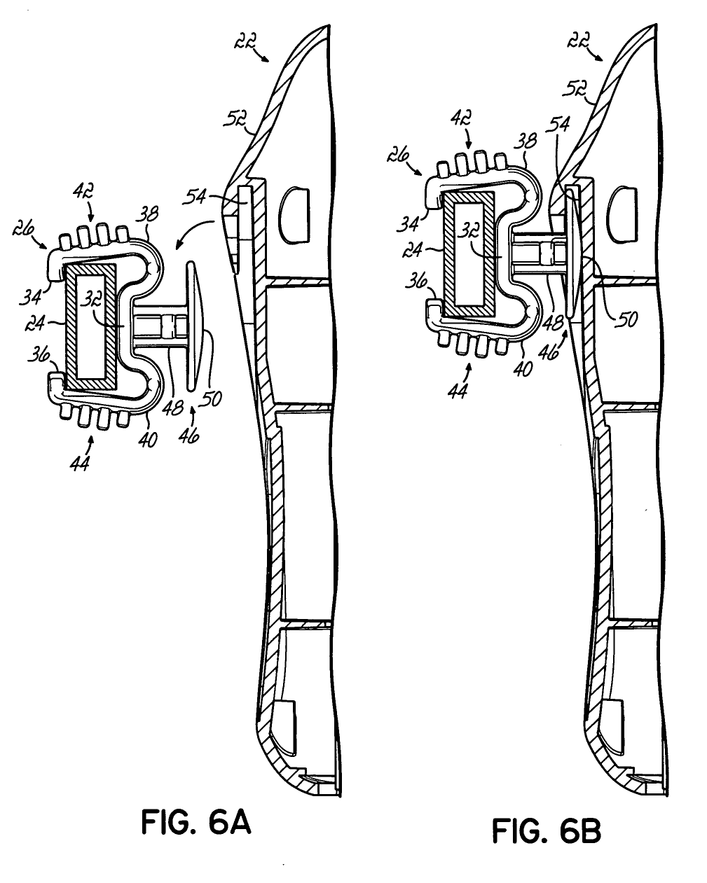

The clamp 26, as best seen in FIGS. 1, 1A, 6 and 6A has opposed jaws 28 and 30 and a bight portion 32. Each jaw 28 and 30 has a terminal end 34 and 36, respectively, projecting inwardly toward each other and reversely curved portions 38 and 40 joining said bight portion 32. A plurality of ribs 42 and 44 project outwardly from and longitudinally of outer surfaces of the jaws 28 and 30, respectively, with said ribs tapering in height from a maximum height medially of said jaws.

As best seen in FIGS. 6A and 6B of the drawings, a stud 46 is mounted on and projects outwardly from an outer surface of the bight portion 32. The stud 46 comprises a shank 48 and a disc 50 mounted on an outer end of the shank 48.

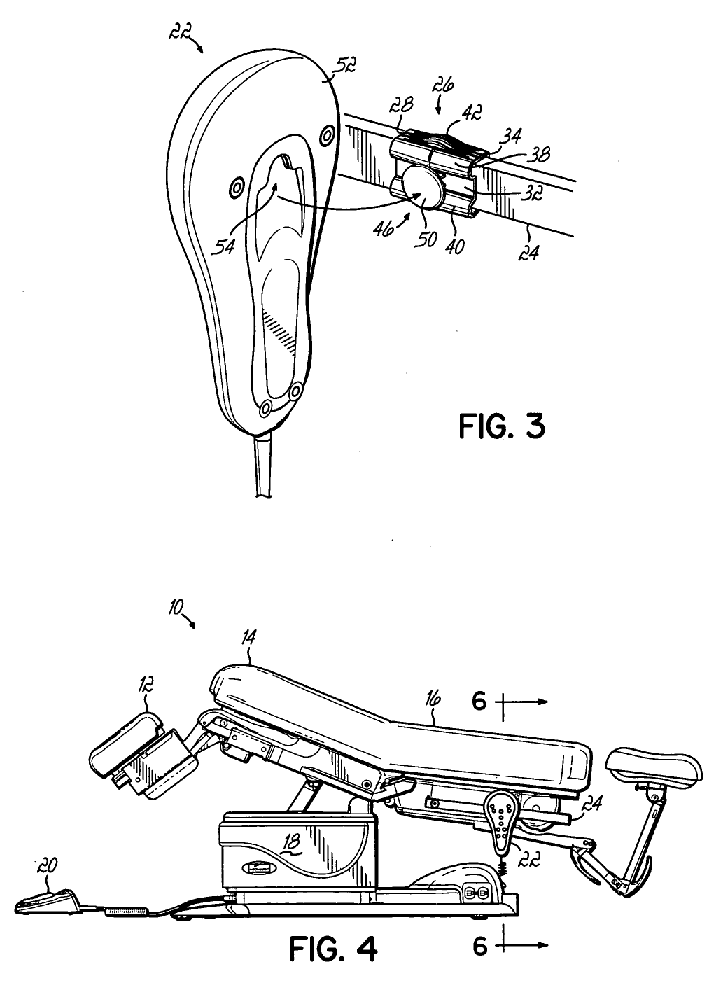

Turning next to FIGS. 3, 6A and 6B of the drawings, the housing 22 is shown in FIG. 3 and the bottom wall thereof is shown in section in FIGS. 6A and 6B. The bottom wall 52 of the housing is of molded one-piece construction and is formed with a keyhole shaped slot complementary in size and shape to the shank and disc 48 and 50 comprising the stud 46. Thus, with the clamp 26 mounted on a side rail of a medical examination table or chair, as shown in FIGS. 3, 6A and 6B, the hand control 22 may be engaged with the clamp by slipping the keyhole slot 54 over the outwardly projecting stud 46 and sliding it down into position, where it is firmly but loosely received.

As a result, once the mounting assembly of the present invention is installed by attaching the clamp 26 to a side rail of a patient supporting device, the hand control housing may be readily attached and detached as needed and when attached, always remains in a substantially vertical orientation as the patient supporting device and the rail associated with it to which the assembly is attached moves through various orientations as the components of the patient supporting device are shifted to various procedural positions.

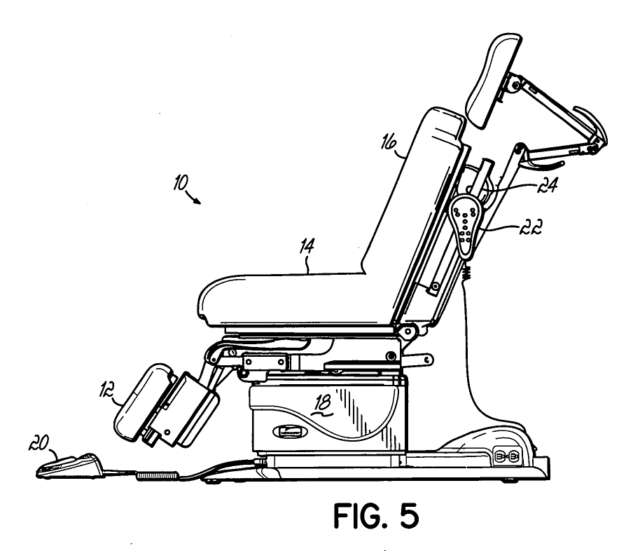

FIG. 4 of the drawings shows one such position in which the side rail 24 is positioned nearly horizontally and the hand control housing is substantially vertically oriented. In FIG. 5 the table 10 has been shifted to a different position, with the rail 24 inclined slightly from the vertical. Nonetheless, the hand control housing still remains substantially vertically oriented and will continue to occupy that position during translational movements between the various procedural positions.

It will be seen, therefore, that the present invention provides, in combination with a patient supporting device, such as a power operated medical examination table or chair, a mounting assembly for the hand control housing, which may be readily attached and detached from a side rail or the like while permitting the hand control, when attached, to remain at a substantially vertical orientation as the patient supporting device is shifted through various procedural positions.

Although the invention has been described in detail with reference to a certain preferred embodiment, variations and modifications exist within the scope and spirit of the present invention as described and defined in the following claims.

What is claimed is:

1. A mounting assembly comprising:
a clamp having opposed jaws and a bight portion,
said opposed jaws and bight portion having inside and outside surfaces,
said inner surfaces being adapted to engage a rail,
a housing including a bottom wall,
said outer surface of said bight portion and said bottom wall of said housing having interengaging components, and
said interengaging components comprise a slot and a stud received in said slot.

2. The assembly of claim 1 wherein:
said stud is loosely received in said slot whereby said housing may freely pivot with respect to said clamp.

3. The assembly of claim 1 wherein:
said housing houses controls for an adjustable patient supporting device.

4. The assembly of claim 1 wherein:
said stud is mounted on said clamp and said slot is formed in said housing.

5. The assembly of claim 1 wherein:
said jaws have terminal ends projecting inwardly toward each other and reversely curved portions joining said bight portion, and
said bight portion is disposed between said terminal ends and said reversely curved portions of said jaws.

6. The assembly of claim 1 wherein:
said outer surfaces of said jaws are provided with a plurality of ribs extending longitudinally of said jaws.

7. The assembly of claim 2 wherein:
said stud projects from said bight portion, and
said slot is formed in said bottom wall of said housing.

8. The assembly of claim 7 further comprising:
a plurality of substantially parallel ribs projecting from and extending longitudinally of said outer surfaces of said jaws.

9. The assembly of claim 8 wherein:
said ribs taper in height from a maximum medially of said jaws.

10. The mounting assembly of claim 1 further comprising:
a patient supporting device having a rail,
said inner surfaces of said jaw and bight portion engaging said rail, and
said rail being translatable between generally horizontal and generally vertical positions.

11. The assembly of claim 10 wherein:
said stud is loosely received in said slot and permits said housing to remain substantially vertically oriented during said translational movement of said rail.

12. The assembly of claim 11 wherein:
said housing houses a control for said patient supporting device.

13. The assembly of claim 12 wherein:
said stud projects outwardly from said outer surface of said bight portion, and
said slot is formed in said bottom wall of said housing.

14. In combination with a patient supporting device movable to different procedural positions the improvement comprising:
a control housing, housing controls for moving said patient supporting device between said different procedural positions,
a clamp attached to said patient supporting device for movement therewith,
said housing and said clamp having interengaging components, and
said interengaging components comprise a slot and a stud loosely received in said slot, whereby
said housing remains substantially vertically oriented as said patient supporting device moves to said different procedural positions.

15. The combination of claim 14 wherein:
said stud projects from said clamp, and
said slot is formed in said housing.

16. The combination of claim 15 wherein:
said clamp has jaws having terminal ends projecting inwardly toward each other and reversely curved portions and a bight portion disposed between said terminal ends and said reversely curved portions.

17. The combination of claim 16 further comprising:
a plurality of ribs projecting outwardly from and longitudinally of outer surfaces of said jaws.

18. The combination of claim 17 wherein:
said clamp is formed of a resilient plastic material.

19. The combination of claim 14 wherein:
said patient supporting device has a rail, and
said clamp is attached to said rail.

20. A patient procedure table having sections articulatable with respect to each other for movement to different procedural positions,
a control unit for controlling movement of said table sections,
a rail mounted on said-table,
a resilient clamp having opposed jaws and a bight portion,
said opposed jaws having terminal ends projecting inwardly toward each other and reversely curved portions joining said bight portion,
said bight portion being disposed between said terminal ends and said reversely curved positions,
said clamp having inner and outer surfaces with said inner surfaces thereof engaging said rail and with said terminal ends and said bight portion engaging opposite surfaces of said rail,
a stud comprising a shank and a disc mounted on an end of said shank with said stud projecting from said outer surface of said bight portion,
a plurality of ribs projecting outwardly from and longitudinally of said outer surfaces of said jaws,
said control unit having a bottom wall, and
a key hole-shaped slot formed in said bottom wall and receiving said stud, whereby
said control unit remains substantially vertically oriented as said table is moved to different procedural positions.
